(19) United States
(12) Patent Application Publication
(10) Pub. No.: US 2019/0370708 A1
(43) Pub. Date: Dec. 5, 2019

(54) CARBON ASSET RISK MANAGEMENT METHOD

(71) Applicant: YC CONSULTANTS, LTD., Taichung City (TW)

(72) Inventors: SHIN-CHIH SHIH, Taichung City (TW); SU-CHUAN YEN, Taichung City (TW)

(21) Appl. No.: 15/994,065

(22) Filed: May 31, 2018

(51) Int. Cl. G06Q 10/06

(52) U.S. Cl. CPC G06Q 10/0635; G06Q 10/06375

(57) ABSTRACT

A carbon asset risk management method is carried out by a calculation device for selecting a target carbon emission allowance increasing means from a plurality of carbon emission allowance increasing means candidates according to a first property and a second property of each means candidate. The carbon asset risk management method includes following steps: (a) selecting at least a first means candidate from a plurality of carbon emission allowance increasing means candidates, the first property of each selected first selection being identical; (b) selecting a first means candidate as the target carbon emission allowance increasing means from the selected first means candidates; and (c) repeatedly carrying out step (a) and step (b) until a predetermined finish condition is met. Therefore, a high efficient carbon asset risk management solution is achieved.

### BACKGROUND OF THE INVENTION

### 1. Field of the Invention

The present invention relates to carbon asset risk management methods, and more particularly, to a carbon asset risk management method which selects and combines multiple means to increase carbon emission allowances.

### 2. Description of the Related Art

In order to reduce global greenhouse gas emissions, governments and international organizations are imposing carbon emission allowance limitations on various industries, so as to allocate carbon emission allowances to individual enterprise by law. When the carbon emission allowance allocated to the enterprise is unable to meet the emission requirement, emission allowances can be managed by three ways, namely carbon trading, on-site emissions reduction, and off-site emissions reduction. Regarding carbon trading, the carbon emission allowance is purchased through carbon trading market, such as exchange or auction platform, so as to fulfill the carbon emission allowance requirement of individual enterprise. Regarding on-site emissions reduction, manufacturing equipment of the enterprise are improved to lower the carbon emission of the enterprise. For example, if the carbon emission of the enterprise before the on-site emission reduction is 500 tons, and the carbon emission after the on-site emission reduction is 400 tons, a 100 tons of demand for emission allowances of the enterprise is reduced. Regarding off-site emissions reduction, the enterprise offers assistance for greenhouse gas emissions reduction project outside of the factories. However, such emissions reduction project shall meet the carbon emissions offset standard recognized by the government or international standards.

Each way for managing carbon emission allowances has different properties, such as legal limitation, hedging period, or corresponding unit cost. Therefore, it is desired for an enterprise to select and combine suitable management method for carbon emission allowance to meet the enterprise requirement.

### SUMMARY OF THE INVENTION

For improving the issues above, a highly efficient carbon asset risk management method is disclosed by the present invention.

For achieving the aforementioned objectives, a carbon asset risk management method is provided, which is carried out by a calculation device for selecting a target carbon emission allowance increasing means from a plurality of means candidates according to a first property and a second property of each means candidate, the carbon asset risk management method including following steps: step (a), step (b), and step (c). In step (a), at least a first means candidate having the first property meeting a first property requirement is selected from the plurality of means candidates, wherein the first properties of each selected first means are identical. In step (b), when more than one first means candidates are selected, one of the first means candidates having the second property meeting a second property requirement is selected as the target carbon emission allowance increasing means, wherein when only one first means candidate is selected in the step (a), the only one first means candidate is selected as the target carbon emission allowance increasing means. In step (c), step (a) and step (b) are repeatedly carried out until a predetermined finish condition is met.

Therefore, a highly efficient carbon asset risk management solution is provided.

### BRIEF DESCRIPTION OF THE DRAWINGS

FIG. 1 is a block diagram illustrating the calculation device configured to carry out the carbon asset risk management method in accordance with an embodiment of the present invention.

FIG. 2 is a flow chart illustrating the steps included in the carbon asset risk management method in accordance with an embodiment of the present invention.

### DETAILED DESCRIPTION OF THE INVENTION

The aforementioned and further advantages and features of the present invention will be understood by reference to the description of the preferred embodiment in conjunction with the accompanying drawings.

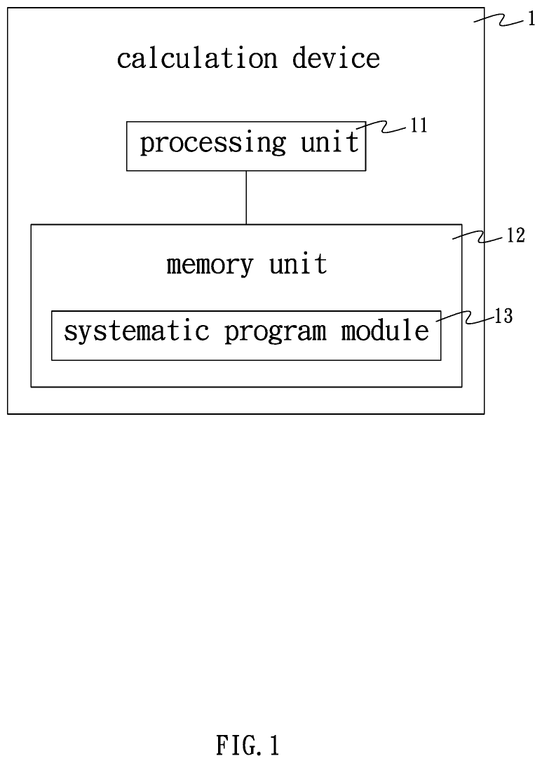

Referring to FIG. 1, the carbon asset risk management method in accordance with an embodiment of the present invention is carried out by a calculation device 1. The calculation device 1 includes a processing unit 11 and a memory unit 12. A systematic program module 13 is stored in the memory unit 12. The calculation device 1 carries out the carbon asset risk management method in accordance with an embodiment of the present invention by executing the systematic program module 13.

The carbon asset risk management method in accordance with an embodiment of the present invention is applied to select a target carbon emission allowance increasing means from a plurality of means candidates according to a first property, a second property, a third property, and an allowance offer of each means candidate to combine to acquire a suitable carbon emission allowance meeting the enterprise requirement.

In an embodiment of the present invention, the first property refers to, for example but not limited to, a “unit cost”. The second property refers to, for example but not limited to, a “category”. The third property refers to, for example but not limited to, a “hedging period”. The second property refers to a category selected from a first category, a second category, and a third category, wherein the selected category corresponds to a priority order, such that the first category corresponds to the highest priority order, the second category corresponds to the second priority order, and the third category corresponds to the lowest priority order.

Also, the second category corresponds to a first allowance limitation, the third category corresponds to a second allowance limitation, and the first category corresponds to no allowance limitation. In addition, the “hedging period” of the carbon emission allowance increasing means represents that the carbon emission allowance increasing means shall be completed in the aforementioned hedging period. For example, if the hedging period of a carbon emission allowance increasing means is three years, the carbon emission allowance increasing means shall be completed in three years.

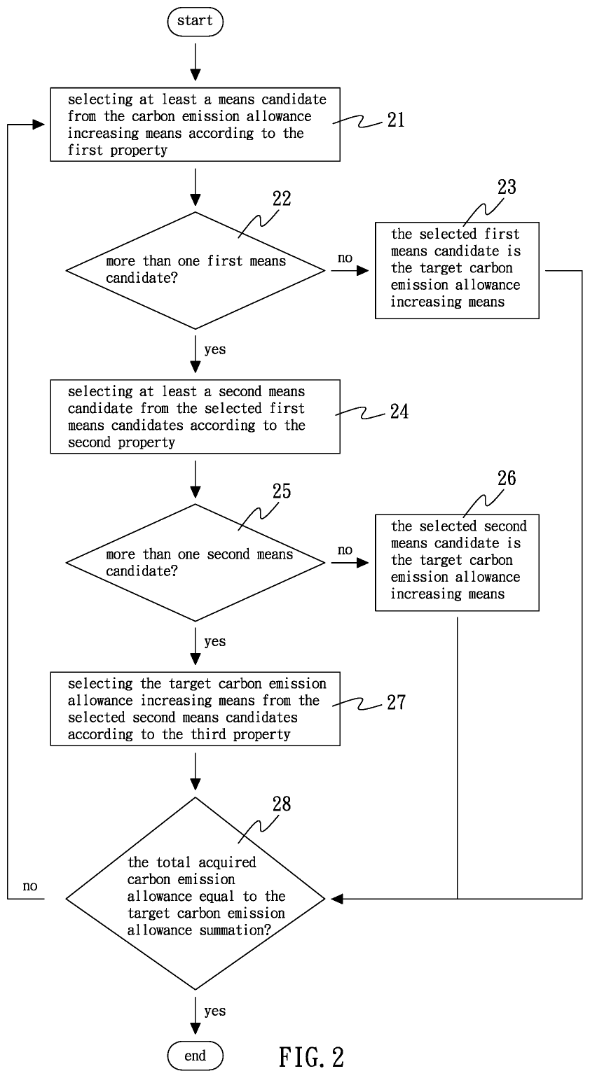

Referring to FIG. 2, in an execution process, the calculation device repeatedly carries out several steps, which includes step 21 to step 28, until a carbon emission allowance summation acquired from the execution of selected carbon emission allowance increasing means reaches an allowance goal. Further, the carbon emission allowance summation acquired from the selected carbon emission allowance increasing means under the second category is not larger than the first allowance limitation; the carbon emission allowance summation acquired from the selected carbon emission allowance increasing means under the third category is not larger than the second allowance limitation.

More particularly, the selected carbon emission allowance increasing means includes following steps. First, choosing at least a first means candidate (step 21), wherein each first means candidates has an identical first property. Next, identifying if a plurality of first means candidates are selected (step 22). When only a single first means candidate is selected, such first means candidate is selected as the target carbon emission allowance increasing means (step 23). When a plurality of first means candidates are selected, at least a second means candidate is selected from the plurality of first means candidates based on the second properties of the plurality of first means candidates (step 24). Next, identifying if a plurality of second means candidates are selected (step 25). When only a single second means candidate is selected, such second means candidate is selected as the target carbon emission allowance increasing means (step 26). When a plurality of second means candidates are selected, the target carbon emission allowance increasing means is selected from the plurality of second means candidates based on the third properties of the plurality of second means candidates (step 27).

For example, in the attached Table 1, ten carbon emission allowance increasing means are included, wherein the carbon emission allowance increasing means under the first category is an on-site emissions reduction means, the carbon emission allowance increasing means under the second category is either an off-site emission reduction means or a domestic carbon trading means, and the carbon emission allowance increasing means under the third category is a foreign carbon trading means. Also, the first category corresponds to the highest priority order, the second category corresponds to the second priority order, and the third category corresponds to the lowest priority order. If the total carbon emission allowance gap is 130 tons, and, according to the legal limitation, the total carbon emission allowance acquired from the carbon emission allowance increasing means under the second category shall not be larger than 20 tons, and the total carbon emission allowance acquired from the carbon emission allowance increasing means under the third category shall not be larger than 10 tons, the solution of the carbon emission allowance increasing means is described as following.

Referring to the attached Table 1 and Table 2, the target carbon emission allowance increasing means is selected after different selection rounds.

Round 1: The fifth means is selected in the selection round 1 based on the reason that the fifth means has the lowest unit cost, and the allowance provided by the fifth means (6 tons) which is under the third category is lower than the current allowance top limitation (10 tons) corresponding to the third category. Therefore, the current allowance corresponding to the third category is reduced to 4 tons, and the total allowance gap is reduced from 130 tons to 124 tons.

Round 2: The first means and the sixth means have the lowest unit cost among the unselected carbon emission allowance increasing means. Therefore, the categories of the first and sixth means are then compared. The first means is under the third category, and the sixth means is under the second category. Due to the priority order of the second category being higher than the priority order of the third category, the sixth means is selected in round 2. The allowance provided by the sixth means (3 tons) is lower than the current allowance top limitation (20 tons) corresponding to the second category. Therefore, when the sixth means is selected, the current allowance top limitation corresponding to the second category is reduced to 17 tons, and the current total allowance gap is reduced to 121 tons.

Round 3: The first means has the lowest unit cost among the unselected carbon emission allowance increasing means. Therefore, the first means is selected in round 3. Also, the allowance provided by the first means (18 tons) which is under the third category is larger than the current allowance top limitation corresponding to the third category (4 tons), so that only 4 tons of the allowance are allowed to be covered by the first means. Therefore, when the first means is selected, the current allowance top limitation corresponding to the third category is reduced to 0 tons, and the current total allowance gap is reduced to 117 tons.

Round 4: The second means and the seventh means have the lowest unit cost among the unselected carbon emission allowance increasing means. Therefore, the categories of the second and seventh means are then compared. The second means is under the second category, and the seventh means is under the first category. Due to the priority order of the first category is higher than the priority order of the second category, the seventh means is selected in round 4. The allowance provided by the seventh means (16 tons) is lower than the current total allowance gap (117 tons), so that 16 tons of the total allowance gap are allowed to be covered by the seventh means. Therefore, when the seventh means is selected, the current total allowance gap is reduced to 101 tons.

Round 5: The second means has the lowest unit cost among the unselected carbon emission allowance increasing means. Therefore, the second means is selected in round 5. Also, the allowance provided by the second means (4 tons) which is under the second category is lower than the current allowance top limitation corresponding to the second category (17 tons), so that 4 tons of the total allowance gap are allowed to be covered by the second means. Therefore, when the second means is selected, the current allowance top limitation corresponding to the second category is reduced to 13 tons, and the current total allowance gap is reduced to 97 tons.

Round 6: The fourth means has the lowest unit cost among the unselected carbon emission allowance increasing means. Therefore, the forth means is selected in round 6. Also, the allowance provided by the forth means (3 tons) which is under the second category is lower than the current allowance top limitation corresponding to the second category (13 tons), so that 3 tons of the total allowance gap are allowed to be covered by the fourth means. Therefore, when the forth means is selected, the current allowance top limitation corresponding to the second category is reduced to 10 tons, and the current total allowance gap is reduced to 94 tons.

Round 7: The third means and the tenth means have the lowest unit cost among the unselected carbon emission allowance increasing means. Therefore, the categories of the third and tenth means are then compared. The third means and the tenth means are both under the first category. Therefore, the hedging period of the third and tenth means are then compared. Due to the hedging period of the third means being longer than the hedging period of the tenth means, the third means is selected in round 7. The allowance provided by the third means (50 tons) is lower than the current total allowance gap (94 tons), so that 50 tons of the total allowance gap are allowed to be covered by the third means. Therefore, when the third means is selected, the current total allowance gap is reduced to 44 tons.

Round 8: The tenth means has the lowest unit cost among the unselected carbon emission allowance increasing means. Therefore, the tenth means is selected in round 8. Also, the allowance provided by the tenth means (60 tons) which is under the first category is larger than the current total allowance gap (44 tons), so that all 44 tons of the total allowance gap are allowed to be covered by the tenth means. Therefore, when the tenth means is selected, the current total allowance gap is reduced to 0 tons.

Specifically, after the aforementioned selection from round 1 to round 8, a highly efficient carbon asset risk management solution is combined to be acquired. Further, according to the aforementioned description, although a total of three properties of means candidates are included in the present embodiment, it is obvious that the amount of the properties of means candidates is not limited to three and allowed to be two or more, which is only a simple variation of the embodiments.

Furthermore, in an embodiment of the present invention, the finish condition for stopping the repeatedly carried out carbon emission allowance increasing means selection rounds is not limited to “acquiring a predetermined target allowance summation from all the carbon emission allowance increasing means candidates”, and is allowed to be “limiting the total cost of the carbon emission allowance increasing means to be not higher than a predetermined target cost summation”. For example, referring to Table 2, if the target cost summation is 300 dollars, a corresponding carbon asset risk management solution is acquired by combining the carbon emission allowance increasing means selected from round 1 to round 6.

TABLE 1
Ten Carbon Emission Allowance Increasing Means

| carbon emission | | | hedging | allowance |
|---|---|---|---|---|
| allowance increasing | unit cost | | period | provided |
| means | (dollar/ton) | category | (year) | (ton) |
| first means | 5 | third | 3 | 18 |
| second means | 6 | second | 3 | 4 |
| third means | 12 | first | 4 | 50 |
| fourth means | 7 | second | 2 | 3 |
| fifth means | 4 | third | 2 | 6 |
| sixth means | 5 | second | 1 | 3 |
| seventh means | 6 | first | 1 | 16 |
| eighth means | 15 | second | 7 | 3 |
| ninth means | 13 | second | 5 | 2 |
| tenth means | 12 | first | 3 | 60 |

TABLE 2
Selected Carbon Emission Allowance Increasing Means

| | | | | current emission | current emission | |
|---|---|---|---|---|---|---|
| | | | | allowance top | allowance top | |
| | selected carbon | allowance | total emission | limitation of the | limitation of the | cost |
| | emission allowance | covered | gap after selection | second category | third category | summation |
| round | increasing means | (ton) | (ton) | (ton) | (ton) | (dollar) |
| 1 | fifth means | 6 | 124 | 20 | 4 | 24 |
| 2 | sixth means | 3 | 121 | 17 | 4 | 39 |
| 3 | first means | 4 | 117 | 17 | 0 | 59 |
| 4 | seventh means | 16 | 101 | 17 | 0 | 155 |
| 5 | second means | 4 | 97 | 13 | 0 | 179 |
| 6 | fourth means | 3 | 94 | 10 | 0 | 200 |
| 7 | third means | 50 | 44 | 10 | 0 | 800 |
| 8 | tenth means | 44 | 0 | 10 | 0 | 1328 |

To sum up, by setting up the selection priority order of different properties of the carbon emission allowance increasing means candidates, a plurality of carbon emission allowance increasing means are selected and combined according to the priority orders, so as to achieve a highly efficient carbon asset risk management solution.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A carbon asset risk management method which is carried out by a calculation device for selecting a target carbon emission allowance increasing means from a plurality of carbon emission allowance increasing means candidates according to a first property and a second property of each means candidate, the carbon asset risk management method including following steps:
(a) selecting at least a first means candidate from the plurality of carbon emission allowance increasing means candidates according to the first property of each means candidate, each selected first means candidate having the identical first property;
(b) when more than one first means candidates are selected, selecting a first means candidate from the first means candidates selected in step (a) according to the second property of each selected first means candidate; when only one first means candidate is selected in step (a), selecting the only one first means candidate as the target carbon emission allowance increasing means;
(c) repeatedly carrying out step (a) and step (b) until a predetermined finish condition is met.

2. The carbon asset risk management method of claim 1, wherein the first property refers to a “unit cost”, the second property refers to a “category” corresponding to a priority order; in step (a), the at least a first means candidate has a lowest unit cost of carbon emission allowance increasing means; in step (b), when more than one first means candidate are selected, the selected target carbon emission allowance increasing means has the second property corresponding to a highest priority order among the second properties of other first means candidates selected in step (a).

3. The carbon asset risk management method of claim 1, wherein each carbon emission allowance increasing means has a third property; in step (b), when more than one first means candidate are selected in step (a), at least one second means candidate having the identical second property is selected from the selected first means candidates; when more than one second means candidate are selected, selecting one of the second means candidate as the target carbon emission allowance increasing means from the selected second means candidates according to the third property of each selected second means candidate; when only one second means candidate is selected, selecting the only one selected second means as the target carbon emission allowance increasing means.

4. The carbon asset risk management method of claim 3, wherein the first property refers to a “unit cost”, the second property refers to a “category” corresponding to a priority order; and the third property refers to a “hedging period”; in step (a), the at least a first means candidate has a lowest unit cost of carbon emission allowance increasing means; in step (b), when more than one first means candidate are selected, the selected target carbon emission allowance increasing means has the second property corresponding to a highest priority order among the second properties of other first means candidates selected in step (a); when more than one second means candidate are selected, the selected target carbon emission allowance increasing means has the third property corresponding to a longest hedging period among the hedging periods of other second means candidates selected.

5. The carbon asset risk management method of claim 2, wherein the second property is chosen from a group consisting a first category and a second category, the priority order corresponding to the first category being higher than the priority order corresponding to the second category, the second category corresponding to an allowance top limitation, and each carbon emission allowance increasing means corresponding to an allowance offer; in step (b), a carbon emission allowance acquired from the selected carbon emission allowance increasing means is not larger than the allowance offer corresponding to the selected carbon emission allowance increasing means; in step (c), a total carbon emission allowance acquired from the selected carbon emission allowance increasing means which are under the second category is not larger than the allowance top limitation.

6. The carbon asset risk management method of claim 4, wherein the second property is chosen from a group consisting a first category and a second category, the priority order corresponding to the first category being higher than the priority order corresponding to the second category, the second category corresponding to an allowance top limitation, and each carbon emission allowance increasing means corresponding to an allowance offer; in step (b), a carbon emission allowance acquired from the selected carbon emission allowance increasing means is not larger than the allowance offer corresponding to the selected carbon emission allowance increasing means; in step (c), a total carbon emission allowance acquired from the selected carbon emission allowance increasing means which are under the second category is not larger than the allowance top limitation.

7. The carbon asset risk management method of claim 1, wherein in step (b), a carbon emission allowance acquired from the selected carbon emission allowance increasing means is not larger than the allowance offer corresponding to the selected carbon emission allowance increasing means; in step (c), the finish condition is to acquire a total carbon emission allowance from the selected carbon emission allowance increasing means, such that the total carbon emission allowance acquired is substantially equal to a predetermined target allowance summation.

8. The carbon asset risk management method of claim 1, wherein in step (b), a carbon emission allowance acquired from the selected carbon emission allowance increasing means is not larger than the allowance offer corresponding to the selected carbon emission allowance increasing means; in step (c), the finish condition is to limit a total cost of the selected carbon emission allowance increasing means to be not higher than a predetermined target cost summation, such that the steps of the carbon asset risk management method are no longer repeatedly carried out when the total cost is higher than the predetermined target cost summation.
